(19) United States
(12) Patent Application Publication
(10) Pub. No.: US 2007/0290155 A1
(43) Pub. Date: Dec. 20, 2007

(54) Actuation Device

(76) Inventor: Heinz Jacobus, Dudweiler (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/597,053

(22) PCT Filed: Jul. 1, 2005
(86) PCT No.: PCT/EP05/07119

§ 371 Date: Nov. 20, 2006

(30) Foreign Application Priority Data
Oct. 21, 2004 (DE) 10 2004 051 331.7

(51) Int. Cl. F16K 31/06

(52) U.S. Cl. 251/65

(57) ABSTRACT

The invention relates to an actuation device, in particular an actuation magnet, which is used to control valves. Said actuation device comprises a housing and a coil body which is arranged therein, and whereon a magnet armature can be guided in a longitudinal manner and the magnet armature is provided with the winding of the conductor. The ends of the conductors (40,42) are received by a retaining device (50) which connects a contacting device (44) to contacting rings (52, 54) for each end of the conductor (40, 42). As a result, the contacting device (44) is provided with parts thereof in at least one recess (46,48) of the retaining device (50) and that the respective contacting rings (52, 54) lead into a plug part (56, 58), and the contacting device, contrary to possible connection possibilities in prior art, can only be connected to the retaining device and after the conductor ends of the coil windings are connected to the respective contacting rings, it is electrically connected via the respective plug part of the contacting device.

The invention relates to an actuation device, in particular an actuating magnet, for actuating valves, having a housing and a coil element located therein, a coil element in which a magnetic armature is guided to be longitudinally movable, and which is provided with the winding of a conductor, the conductor ends being held by a retaining device which enables connection of a contact-making means with contact-making clips for each end of the conductor.

These actuation devices which are also termed actuating magnets are known and are freely available commercially in a host of versions. The actuating part, also called a magnetic armature or switching component, is formed essentially from a tubular or rod-shaped pin which, when the coil is electrically excited, traverses a definable path via a connector plug which can be connected to a plug plate and in the process actuates an actuating or switching process, and for example, in a valve enables blocking and routing of fluid flows. If these known actuation devices are used in regions with high humidity, as arises among other things also with condensate formation, the moisture penetrates into the housing interior, especially to the coil element with the winding, and with the penetration of moisture leads to the device becoming unusable. To avoid this problem it has already been suggested in the prior art that the housing of the actuation device be completely surrounded with a plastic potting mass which keeps moisture away; but this can lead to actuation devices of very large size which are not suited for use in automotive engineering, where fundamentally only little installation space is available.

Moreover, in a generic actuation device as claimed in DE 43 41 087 A1 it has already been suggested that a plug insert for seating of an annular sealing component be provided with a seating surface which protrudes with a definable axial projection over the bottom of the plug plate facing the outer peripheral surface of the housing, such that in the installed state at least the gap which is formed in the direction of the coil element between the plug plate and the outer peripheral surface of the housing is closed to effect sealing by pressing the sealing component. In this way moisture can no longer travel at the site of the upper part of the plug plate into the housing interior and in particular cannot reach the coil element with the winding. In the known solution the plug insert has an inside thread and two insulation piercing inserts which are each provided with lengthwise teeth and which are separated from one another by a groove-shaped contact shoulder for holding the annular sealing component. In this way, with simple manufacture the plug insert can be securely joined both to the plug plate and also then together with the plug plate to the housing of the actuation device. Since in the known solution the gap formation in the area of the plug plate between the potting mass and the outer peripheral surface of the housing is extremely narrow and in this respect is then closed by the annular sealing component in the pressed state, the sealing component in the direction of the gap is very greatly extended and compressed; this can lead to high material loading in the annular sealing component and, especially due to the sharp-edge configuration of the insulation piercing inserts, damage to the sealing component is possible. Furthermore, these solutions in the prior art are expensive and complex to produce due to the diversity of parts and otherwise producing the contact-making between the ends of the conductor of the coil winding and the actual plug insert is not always easy.

On the basis of this prior art, the object of the invention is to devise an actuation device as compact in size as possible which is suited especially for use in automotive engineering and which is still reliable in operation even at high humidity, and with few components allows economical implementation, especially relative to the electrical connection configuration for the coil winding. This object is achieved by an actuation device with the features of claim 1 in its entirety.

In that, as specified in the characterizing part of claim 1, the contact-making means with parts of it is inserted into at least one recess of the retaining device and in that the respective contact-making clip ends in a plug part, in contrast to the complicated connection options in the prior art the contact-making means need only be mechanically connected to the retaining device and after connection of the conductor ends of the coil winding to the respective contact-making clip, electrical connection takes place via the respective plug part of the contact-making means. Since this contact-making possibility fundamentally lies outside the region of the housing with the coil winding, the sealing problems to be managed are reduced and by the corresponding application of a plastic potting mass the actuation device as claimed in the invention is tight against moisture and other fluid media along its outer periphery. Due to the technically simple connection potential, possible sealing problems are reduced overall so that a small amount of applied plastic is sufficient to subsequently ensure effective sealing. Accordingly, the actuation device as claimed in the invention can be made compact. Furthermore it can be economically produced in light view of the small number of parts.

In one preferred embodiment of the actuation device as claimed in the invention, the respective contact-making clip is formed from two U-shaped or V-shaped leg pieces, of which one undergoes transition into the plug part. Then the respective conductor end for a contact connection can be inserted between the leg pieces formed in this way.

In another preferred embodiment of the actuation device as claimed in the invention, the two legs of the contact-making clip are made as flat parts and the plug part is made as a cylindrical terminal pin. As a result of the configuration as flat parts, a good wire insertion aid for the conductor ends is formed, in addition to their secure attachment within the contact-making clip. Making the plug part as a cylindrical terminal pin allows use of standardized components; this benefits production costs. Furthermore, the configuration as a terminal pin is in turn space-saving. Preferably, provision is preferably furthermore made such that one leg of the contact-making clip on its free end can be spread apart from the other assigned leg in order in this way to facilitate insertion of the conductor end, with already defined fixing in the area of the spread end being able to take place for the respective conductor end.

In another, especially preferred embodiment of the actuation device as claimed in the invention, provision can be made so that at least one leg of a contact-making clip is made spring-elastic. Due to this spring elasticity, on the one hand the respective conductor end can be squeezed between the legs and on the other hand also due to elastic flexibility clamping contact can be created within the respective recess in the retaining device for the assignable contact-making clip.

Other advantageous embodiments are the subject matter of the other dependent claims.

The actuation device as claimed in the invention will be detailed below using one embodiment as shown in the drawings. The figures are schematic and not to scale.

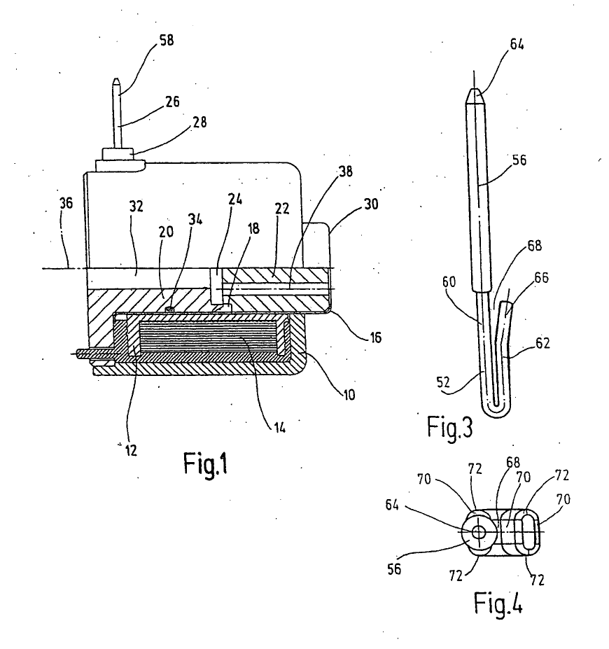

FIG. 1 shows partially in a front view, partially in a longitudinal section, the important components of the actuation device;

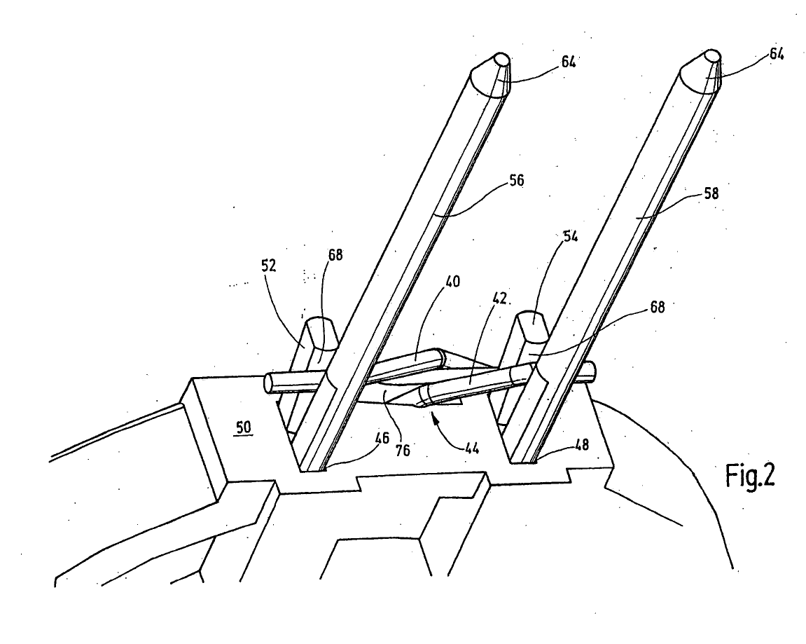

FIG. 2 shows in a perspective top view a retaining device with the contact-making means inserted;

FIG. 3 shows a side view of the contact-making clip with the plug part;

FIG. 4 shows a top view of the contact-making clip with the plug part as shown in FIG. 3.

The actuation device shown in FIG. 1 at the bottom in a longitudinal section, which can also be termed a switching or actuating magnet in technical jargon has a housing 10 with a coil element 12 located therein with a coil winding 14. This coil element 12 comprises at least in part a pole tube 16 which is essentially magnetically decoupled from the pole core 20 by means of a separation 18 in the form of a weld or, as shown, in the form of an exposed point. Along the pole tube 16 a magnetic armature 22 is guided in the armature space 24 which on its one free front end interacts with a rod-like actuating part which is not shown for actuating fluid valves of conventional design which are not shown. To energize the coil winding 14 of the coil body 12, there is a plug connecting part 26 which is preferably securely connected to the housing 10 via a potting mass 28. On its one free end, the pole core 20 is enlarged in diameter and in this way forms a type of pole plate. On the opposite end, the pole tube 16 has a crimped edge 30 as a lift and stop limitation for the magnetic armature 22 which is shown in its rightmost, unactuated operating position in the direction of looking at FIG. 1.

If the coil winding 14 and therefore the coil are energized via the plug connection part 26, the magnetic armature 22 is moved into its actuated position, viewed in the direction of looking at FIG. 1, from a right-hand stop or rest position into a left-hand actuating position which is not detailed. In this traveling motion the magnetic armature 22 entrains the rod-shaped actuating part which is not detailed for the fluid valve, with a free end for the actuation process on the valve which is not detailed which emerges at least partially from the housing 10. The actuating part which is not detailed is routed within the pole core 20 in a longitudinal channel 32 which is connected to the armature space 24 to carry fluid. Furthermore, the inner peripheral side of the pole tube 16 is placed against the pole core 20 by way of a sealing means 34 in the form of an O-ring which is located in a groove-shaped recess in the pole core 20. The magnetic armature 22 in its axial travel direction along the longitudinal axis 36 of the actuation device is provided with at least one fluid compensation channel 38 which makes it possible to move the fluid located in the armature or chamber space back and forth within the space depending on the travel position of the magnetic armature 22 in order in this way to avoid obstacles in operation. For the resetting motion of the magnetic armature 22 into its initial position shown in FIG. 1, the coil winding 14 then can no longer be energized and the resetting motion takes place forcibly via reset spring (not shown) which as part of the valve via the valve plunger can set back the rod-shaped actuating part and therefore the magnetic armature 22.

Even when the current is removed, however, due to residual magnetism processes in the pole core 20, the magnetic armature 22 with its one free end front side may adhere to the adjacent front side of the pole core 20 facing it. To prevent this, there can be an antiadhesion disk which is not detailed in the armature space 24 between the front-side ends of the pole core 20 and the magnetic armature 22 which are adjacent to one another.

To connect the two conductor ends 40, 42 (compare FIG. 2) of the coil winding 14, a contact-making means designated as a whole as 44 is used which is inserted with parts of it into recesses 46, 48 of a retaining device 50. This retaining device 50 forms a type of plastic ring and on its free front end encompasses the pole core 20 with its longitudinal channel 32. Furthermore, the contact-making means 44 has two contact-making clips 52, 54 which are spatially separated from one another and which end on their one free end in a pin-like plug part 56, 58.

As is furthermore to be seen from FIG. 3, the respective contact-making clip 52, 54 has two U-shaped leg pieces 60, 62, of which one undergoes transition into the respective plug part 56, 58. Instead of a U-shaped configuration, the leg pieces 60, 62 on their facing ends also could also form a V-shape (not shown). Furthermore, the two legs 60, 62 of a contact-making clip 52, 54 are made as flat parts and the plug part 56, 58 is made as a cylindrical connecting pin with a conically tapering connection end tip 64. As follows furthermore from FIG. 3, one leg 62 of a contact-making clip 52, 54 on its free end 66 can be spread apart from the other assigned leg 60. In this way, between the two legs 60, 62 of the contact-making clip 52, 54 a receiving space 68 for holding the respective conductor end 40, 42 is delineated. If the respective conductor end 40, 42 is inserted into the assignable receiving space 68 of a clip 52, 54, electrical contact making between the respective contact-making clip 52, 54 and the indicated conductor end can be produced via a solder or weld spot connection which is not detailed. In this way then the electrical connection possibility is also formed by way of the two plug parts 56, 58.

Instead of the indicated possibility, it would also be conceivable to make at least one leg 62 spring-elastic in order to obtain a clamping possibility for the assignable conductor end 40, 42 on the bottom of the clamp-shaped contact-making clip 52, 54. Furthermore, spring-elastic, spreadable legs 60, 62 (not shown) could ensure clip-like attachment of the respective contact-making clip 52, 54 in the recess 46, 48 within the retaining device 50. In this illustrated embodiment, however the respective contact-making clip 52, 54, as shown, is only inserted from overhead into the recess 46, 48, and its remaining in the recess 46, 48 is ensured by the injection plastic material to be applied, which then extends in any case over the free top end of the leg 62 of each contact-making clip 52, 54 and consequently also covers the conductor ends 40, 42. In this respect, as shown in FIG. 1, only the two pin-like plug parts 56, 58 project above the potting mass 28.

In the configuration as shown in FIG. 2, the respective flat parts of the contact-making clip 52, 54 are oriented in the longitudinal direction to the longitudinal axis 36 of the actuation device. In one preferred configuration as shown in FIG. 4 however, the flat parts 70 in contrast to FIG. 2 run transversely to the longitudinal axis 3 of the device; this has the advantage that to a greater extent fixing surfaces are available for the purpose of holding the conductor ends 40, 42. The actual flat parts 70 as shown in FIG. 4 then undergo transition into arc-shaped connecting pieces 72 on the two end sides.

As shown in FIG. 2, between the two rectangularly shaped recesses 46, 48 within the retaining device 50 there runs a guide recess 76 which runs transversely thereto for guiding the conductor end 42. The other conductor end 40 is conversely guided to the holding space 68 of the contact-making clip 52 by way of an oblique guide which is not detailed on the inside of the retaining device 50. Here it is essential that electrical insulation between the conductor ends 40, 42 is established via the wall parts of the retaining device 50.

The actuation device as claimed in the invention with its contact-making means 44 can be economically produced, seals well even in the region of the injected or potted plug connection part 26, and the pin-like configuration of the plug parts 56, 58 allows not only use of standard plug parts (not shown), but the entire design to be made space-saving and economical.

1. Actuation device, in particular an actuating magnet, for actuating valves, with a housing (10) and a coil element (12) which is located therein, a coil element (12) in which a magnetic armature (22) is guided to be able to move longitudinally, and which is provided with the winding (14) of a conductor, the conductor ends (40, 42) being held by a retaining device (50) which enables connection of a contact-making means (44) with contact-making clips (52, 54) for each end (40, 42) of the conductor, characterized in that the contact-making means (44) with parts of it is inserted into at least one recess (46, 48) of the retaining device (50) and that the respective contact-making clip (52, 54) ends in a plug part (56, 58).

2. The actuation device as claimed in claim 1, wherein the respective contact-making clip (52, 54) has two U-shaped or V-shaped leg pieces (60, 62) and wherein one (60) of the two legs undergo transition into the plug part (56, 58).

3. The actuation device as claimed in claim 2, wherein the two legs (60, 62) of the contact-making clip (52, 54) are made as flat parts and the respective plug part (56, 58) is made as a cylindrical terminal pin.

4. The actuation device as claimed in claim 2, wherein one leg (62) of the contact-making clip (52, 54) on its free end (66) can be spread apart from the other assigned leg (60).

5. The actuation device as claimed in claim 2, wherein between the two legs (60, 62) of the contact-making clip (52, 54) a receiving space (68) for holding the respective conductor end (40, 42) is delineated.

6. The actuation device as claimed in claim 2, wherein at least one leg (62) of a contact-making clip (52, 54) is made spring-elastic.

7. The actuation device as claimed in claim 1, wherein the retaining device (50) assigned to each contact-making clip (52, 54) has a preferably rectangular recess (46, 48) into which the end of the contact-making clip (52, 54) opposite the plug part (56, 58) is inserted.

8. The actuation device as claimed in claim 7, wherein between the two rectangularly shaped recesses (46, 48) in the retaining device (50) there is at least one guide recess (76) which runs transversely thereto for guiding at least one conductor end (42).

9. The actuation device as claimed in claim 1, wherein the contact-making means (44) with its contact-making clips (52, 54) held by the retaining device (50) is injected in place with plastic material.
